(19) United States
(12) Patent Application Publication
(10) Pub. No.: US 2025/0300203 A1
(43) Pub. Date: Sep. 25, 2025

(54) Fuel Cell System and Control Method Thereof

(71) Applicants: Hyundai Motor Company, Seoul (KR); Kia Corporation, Seoul (KR)

(72) Inventors: Ji Hoon Ryu, Seoul (KR); Jae Sung Ryu, Seoul (KR); Seung Man Park, Anyang-Si (KR)

(21) Appl. No.: 18/890,061

(22) Filed: Sep. 19, 2024

(30) Foreign Application Priority Data
Mar. 22, 2024 (KR) 10-2024-0039930

(51) Int. Cl. H01M 8/0438; H01M 8/04082; H01M 8/04223; H01M 8/04225; H01M 8/04228; H01M 8/04302; H01M 8/04303; H01M 8/0444; H01M 8/04746

(52) U.S. Cl. CPC H01M 8/04388; H01M 8/04201; H01M 8/04225; H01M 8/04228; H01M 8/04231; H01M 8/04302; H01M 8/04303; H01M 8/04447; H01M 8/04753; H01M 2250/20

(57) ABSTRACT

The system may comprise a fuel cell stack, a hydrogen supply line configured to be coupled to an anode side of the fuel cell stack and supply hydrogen to the fuel cell stack, a hydrogen supply valve, associated with the hydrogen supply line, configured to adjust an amount of hydrogen supplied to the fuel cell stack, and a controller configured to determine, based on a pressure boost request to boost a hydrogen supply pressure, a front-end hydrogen pressure at a front end of the hydrogen supply valve, determine, based on the determined front-end hydrogen pressure, an opening command value of the hydrogen supply valve, and control, based on the determined opening command value, an opening degree of the hydrogen supply valve to boost the hydrogen supply pressure.

### CROSS-REFERENCE TO THE RELATED APPLICATION

This application claims priority to Korean Patent Application No. 10-2024-0039930, filed on Mar. 22, 2024, in the Korean Intellectual Property Office, the disclosure of which is incorporated herein by reference in its entirety.

### TECHNICAL FIELD

The present disclosure relates to a fuel cell system and a control method thereof.

### BACKGROUND

The matters described in this Background section are only for enhancement of understanding of the background of the disclosure, and should not be taken as acknowledgement that they correspond to prior art already known to those skilled in the art.

A fuel cell system may comprise a fuel cell stack, an air supply system, a hydrogen supply system, and a thermal management system. Among the fuel cell system, the hydrogen supply system may perform a process of supplying hydrogen to the fuel cell stack or discharging hydrogen to the outside. The hydrogen supply system may comprise a hydrogen tank which stores hydrogen as a fuel, and the fuel cell stack receives hydrogen from the hydrogen tank. At this time, the pressure of hydrogen supplied to the fuel cell stack may be adjusted through a hydrogen supply valve located on a line connecting the fuel cell stack and the hydrogen tank.

In addition or alternative to hydrogen, oxygen is also supplied to the fuel cell stack through the air supply system. That is, hydrogen is supplied to the anode side of the fuel cell stack, an oxidation reaction of hydrogen proceeds at the anode to generate protons and electrons, and the generated protons and electrons migrate to the cathode of the fuel cell stack through an electrolyte membrane and an external conductive wire, respectively. At the cathode, electrical energy is generated through an electrochemical reaction in which the protons and electrons, having migrated from the anode, and oxygen in the air participate.

Pressures due to hydrogen and oxygen are formed at the anode and the cathode of the fuel cell stack, respectively, an oxygen concentration gradient by location depending on a pressure difference between the anode and the cathode is formed in the fuel cell stack. Here, if the hydrogen pressure of the anode is momentarily boosted to supply hydrogen to the fuel cell stack, the oxygen concentration of the anode is reduced and results in an oxygen concentration gradient difference between the anode and the cathode, and in order to prevent the concentration gradient difference from occurring, oxygen included in the electrolyte membrane flows to the anode. If such a phenomenon occurs, oxygen flows to the anode of the fuel cell stack, and may adversely affect durability of the fuel cell stack.

### SUMMARY

According to the present disclosure, a system may comprise a fuel cell stack, a hydrogen supply line configured to be coupled to an anode side of the fuel cell stack and supply hydrogen to the fuel cell stack, a hydrogen supply valve, associated with the hydrogen supply line, configured to adjust an amount of hydrogen supplied to the fuel cell stack, and a controller configured to determine, based on a pressure boost request to boost a hydrogen supply pressure, a front-end hydrogen pressure at a front end of the hydrogen supply valve, determine, based on the determined front-end hydrogen pressure, an opening command value of the hydrogen supply valve, and control, based on the determined opening command value, an opening degree of the hydrogen supply valve to boost the hydrogen supply pressure.

The system, wherein, based on the pressure boost request, the controller is further configured to determine whether a required state or a state of the fuel cell stack satisfies a precondition, and determine, based on the required state or the state of the fuel cell stack satisfying the precondition, the front-end hydrogen pressure.

The system, wherein, based on a required pressure boost amount associated with the pressure boost request being greater than or equal to a reference pressure boost amount, the controller is further configured to determine that the required state satisfies the precondition. The system, wherein the controller is further configured to determine a hydrogen concentration on the anode side of the fuel cell stack, and determine, based on the determined hydrogen concentration being less than or equal to a reference concentration, that the state of the fuel cell stack satisfies the precondition.

The system, wherein the controller is further configured to determine an operating state of the fuel cell stack, and determine, based on the front-end hydrogen pressure and the determined operating state, the opening command value.

The system, wherein the controller is configured to derive a maximum duty value of the hydrogen supply valve, wherein the hydrogen supply valve is configured to match the front-end hydrogen pressure and the determined operating state through a prestored data map, and determine, based on the derived maximum duty value, the opening command value.

The system, wherein the controller is further configured to determine an oxygen crossover rate on the anode side of the fuel cell stack, and determine, based on the determined oxygen crossover rate, the opening command value.

The system, wherein, after controlling the opening degree of the hydrogen supply valve, the controller is further configured to determine an operating state of the fuel cell stack, and determine, based on the hydrogen supply pressure reaching a boost target pressure while satisfying a pressure boost condition corresponding to the determined operating state, that boosting of the hydrogen supply pressure has been completed.

The system, wherein, based on the fuel cell stack being in a start-up state, the controller is further configured to determine, based on the hydrogen supply pressure reaching the boost target pressure within a required start-up time, that boosting of the hydrogen supply pressure has been completed.

The system, wherein, based on the fuel cell stack being in a shutdown state, the controller is further configured to determine, based on the hydrogen supply pressure reaching the boost target pressure within a required shutdown time, that boosting of the hydrogen supply pressure has been completed.

The system, wherein, based on the fuel cell stack being in an idle state, the controller is further configured to determine, based on the hydrogen supply pressure reaching the boost target pressure while a boosting rate of the hydrogen supply pressure satisfies a target boosting rate, that boosting of the hydrogen supply pressure has been completed.

The system, wherein, based on the fuel cell stack being in a normal drive state, the controller is further configured to determine, based on the hydrogen supply pressure reaching the boost target pressure within a start response time, that boosting of the hydrogen supply pressure has been completed.

The system, wherein, after controlling the opening degree of the hydrogen supply valve, the controller is further configured to determine a hydrogen flow rate of supplied hydrogen until boosting of the hydrogen supply pressure has been completed, and perform, based on the determined hydrogen flow rate exceeding a reference flow rate, a purging process.

According to the present disclosure, a method performed by a fuel cell system for controlling the fuel cell system, the method may comprise determining, based on a pressure boost request to boost a hydrogen supply pressure, a front-end hydrogen pressure at a front end of a hydrogen supply valve, determining, based on the determined front-end hydrogen pressure, an opening command value of the hydrogen supply valve, and controlling, based on the determined opening command value, an opening degree of the hydrogen supply valve to boost the hydrogen supply pressure.

The method, wherein determining the front-end hydrogen pressure comprises determining, based on the pressure boost request, whether a required state or a state of a fuel cell stack of the fuel cell system satisfies a precondition, and determining, based on the required state or the state of the fuel cell stack satisfying the precondition, the front-end hydrogen pressure.

The method, wherein determining the opening command value comprises determining an operating state of a fuel cell stack of the fuel cell system, and determining, based on the front-end hydrogen pressure and the determined operating state, the opening command value.

The method, wherein determining the opening command value comprises, deriving a maximum duty value of the hydrogen supply valve, wherein the hydrogen supply valve is configured to match the front-end hydrogen pressure and the determined operating state through a prestored data map, and determining, based on the derived maximum duty value, the opening command value.

The method, wherein determining the opening command value further comprises determining an oxygen crossover rate on an anode side of a fuel cell stack of the fuel cell system, and determining, based on the determined oxygen crossover rate, the opening command value.

The method, further may comprise, after controlling the opening degree of the hydrogen supply valve, determining an operating state of a fuel cell stack of the fuel cell system, and determining, based on the hydrogen supply pressure reaching a boost target pressure while satisfying a pressure boost condition corresponding to the determined operating state, that boosting of the hydrogen supply pressure has been completed.

The method, further may comprise, after controlling the opening degree of the hydrogen supply valve, determining a hydrogen flow rate of hydrogen supplied until boosting of the hydrogen supply pressure has been completed, and performing, based on the determined hydrogen flow rate exceeding a reference flow rate, a purging process.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 shows an example of a fuel cell system according to one example of the present disclosure;

FIG. 2 shows an example of an opening command value using a data map according to one example of the present disclosure;

FIG. 3 shows an example of a maximum duty value of a hydrogen supply valve according to one example of the present disclosure; and

FIG. 4 and FIG. 5 show examples of a control method of the fuel cell system according to one example of the present disclosure.

### DETAILED DESCRIPTION

In the following description of examples disclosed in the present disclosure, a detailed description of known functions and configurations incorporated herein will be omitted if it may make the subject matter of the present disclosure rather unclear. In addition or alternative, the accompanying drawings are only for easy understanding of the examples disclosed in this specification, and the technical idea disclosed in this specification is not limited by the accompanying drawings and should be understood to include all changes, equivalents or substitutes included in the spirit and technical scope of the present disclosure.

In the following description of the examples, terms, such as “first” and “second”, may be used to describe various elements but do not limit the elements. These terms are used only to distinguish one element from other elements.

If an element or layer is referred to as being “on,” “engaged with,” “connected to,” or “coupled to” another element or layer, it may be directly on, engaged with, connected to, or coupled to the other element or layer, or intervening elements or layers may be present. In contrast, if an element is referred to as being “directly on,” “directly engaged with,” “directly connected to,” or “directly coupled to” another element or layer, there may be no intervening elements or layers present.

Singular expressions may encompass plural expressions, unless they have clearly different contextual meanings.

In the following description of the examples, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same.

In addition or alternative, a unit or a control unit included in names, such as a motor control unit (MCU), a hybrid control unit (HCU), a fuel cell control unit (FCU), and the like, is only a term widely used to name a controller which controls a specific function of a vehicle, and does not mean a generic functional unit.

A controller may include a communication device which communicates with other controllers or sensors to control a function of which the controller takes charge, a memory which stores operating systems, logic commands, input/output information, etc., and at least one processor which performs judgements, calculations, determinations, and the like necessary to control the function of which the controller takes charge.

Hereinafter, examples disclosed in the present disclosure will be described in detail with reference to the accompanying drawings, the same or similar elements will be denoted by the same reference numerals even though they are depicted in different drawings, and a redundant description of these elements will be omitted.

The present disclosure relates to a fuel cell system, and an object thereof is to prevent oxygen from flowing to the anode of a fuel cell stack if hydrogen is momentarily supplied to the anode.

Accordingly, in order to achieve the above object, a fuel cell system and a control method thereof according to one example of the present disclosure will be described.

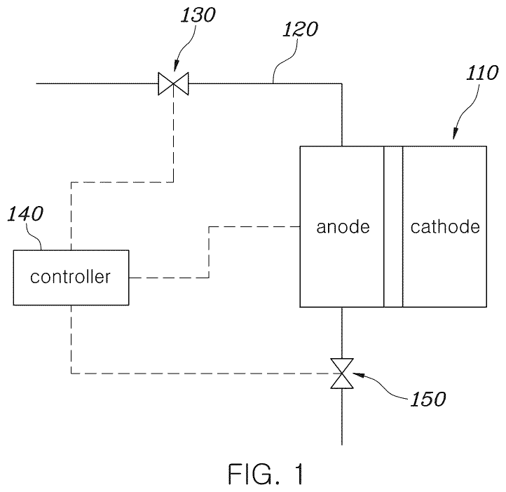

First, the fuel cell system according to one example of the present disclosure will be described with reference to FIG. 1.

FIG. 1 shows an example of the fuel cell system according to one example of the present disclosure.

Referring to FIG. 1, the fuel cell system according to one example of the present disclosure may include a fuel cell stack 110, a hydrogen supply line 120, a hydrogen supply valve 130, and a controller 140. FIG. 1 shows the components related to one example of the present disclosure, and of course, the fuel cell system may include fewer or more components if implementing an actual fuel cell vehicle.

Further, the components of the fuel cell system according to one example of the present disclosure, which will be described below, may be components included in a hydrogen supply system (e.g., a fuel processing system (FPS), a hydrogen refueling stations, hydrogen pipeline networks, hydrogen storage/distribution systems, mobile hydrogen refueling units, etc.), but this is only an example and the present disclosure is not limited thereto.

Hereinafter, the respective components will be described.

The fuel cell stack 110 may be provided with an anode and a cathode, and the hydrogen supply line 120 may be connected to the anode side of the fuel cell stack 110.

The hydrogen supply line 120 may supply hydrogen to the fuel cell stack 110, and here, the hydrogen supply line 120 may be connected to a hydrogen storage tank (not shown), which stores hydrogen, and may supply hydrogen to the fuel cell stack 110.

The hydrogen supply valve 130 is provided on the hydrogen supply line 120 to adjust the amount of hydrogen supplied to the fuel cell stack 110.

The controller 140 may control the hydrogen supply valve 130, and more specifically, may control the hydrogen supply valve 130 to adjust the pressure or amount of hydrogen supplied to the fuel cell stack 110. Specifically, the controller 140 may control opening and closing of the hydrogen supply valve 130 based on an opening command value, and the opening command value may be represented in the form of a pulse width modulation (PWM) duty. The PWM is a technique used to control the amount of power delivered to an electrical load by varying the width of the pulses in a pulse train. The pulse train is a series of on-off pulses, where the width (duration) of the “on” time and “off” time can be adjusted. The PWM duty (duty cycle) is the proportion of the “on” time to the total time period of the pulse. The frequency (e.g., 10 Hertz) of PWM signal is a rate at which the pulses are repeated. The PWM duty is expressed as a percentage value, a PWM duty of 0 may indicate that the hydrogen supply valve 130 is closed, and a PWM duty of 100 may indicate that the hydrogen supply valve 130 is fully open. However, this is only an example and the present disclosure is not limited thereto.

A certain pressure is formed at each of the anode and cathode of the fuel cell stack 110, and thus, an oxygen concentration gradient may be formed in the fuel cell stack 110 due to a pressure difference between the anode and the cathode. Here, if the hydrogen pressure of the anode of the fuel cell stack 110 suddenly increases, such as in a situation in which hydrogen is supplied to the fuel cell stack 110, an oxygen concentration of the anode decreases, and in order to match the concentration gradient between the anode and the cathode, oxygen included in a membrane electrode assembly may move to the anode. Due to this phenomenon, it may be useful to control oxygen not to flow to the anode if hydrogen is supplied to the fuel cell stack 110.

Accordingly, if a pressure boost request to boost a hydrogen supply pressure (e.g., 30-200 kilopascal (kPa)) set to supply hydrogen to the fuel cell stack 110 occurs, the controller 140 according to one example of the present disclosure may prevent a rapid increase in the hydrogen supply pressure due to hydrogen supply to control oxygen not to flow to the anode.

Specifically, in order to control oxygen not to flow to the anode if the pressure boost request to boost the hydrogen supply pressure occurs, the controller 140 may determine a hydrogen pressure at the front end of the hydrogen supply valve 130, i.e., a front-end hydrogen pressure. However, even if the pressure boost request to boost the hydrogen supply pressure occurs, the hydrogen pressure on the anode side of the fuel cell stack 110 may not be rapidly increased in all cases.

Therefore, if the pressure boost request to boost the hydrogen supply pressure occurs, the controller 140 may preferentially determine whether a state depending on the pressure boost request or the state of the fuel cell stack 110 satisfies a predetermined precondition.

For example, the controller 140 may determine a pressure boost amount depending on the pressure boost request to boost the hydrogen supply pressure, and may compare the determined pressure boost amount with a predetermined reference pressure boost amount. Further, if the pressure boost amount is greater than or equal to the predetermined reference pressure boost amount, the controller 140 may determine that the state depending on the pressure boost request satisfies the predetermined precondition. Here, the reference pressure boost amount may mean a lower limit pressure boost amount (e.g., the minimum pressure boost amount) at which the hydrogen pressure rapidly increases due to inflow of a large amount of hydrogen, but this is only an example and the present disclosure is not limited thereto.

In addition or alternative, if the pressure boost request occurs, the controller 140 may determine a hydrogen concentration on the anode side of the fuel cell stack 110, and compare the determined hydrogen concentration with a predetermined reference concentration (e.g., a value that is over 99% and close to 100%). The controller 140 may receive information about the hydrogen concentration on the anode side of the fuel cell stack 110 from a sensor provided to detect the hydrogen concentration of the fuel cell stack 110, and may determine the hydrogen concentration on the anode side of the fuel cell stack 110 if the pressure boost request occurs based on the information. Further, if the determined hydrogen concentration is less than or equal to the predetermined reference concentration, the controller 140 may determine that the state of the fuel cell stack 110 satisfies the predetermined precondition.

Here, the reference concentration may be a hydrogen concentration on the anode side at a point in time if oxygen begins to flow to the anode side of the fuel cell stack 110, and may be an experimental value obtained through experimentation in the ideal state of the fuel cell stack 110. However, this is only an example and the present disclosure is not limited thereto.

If the state depending on the pressure boost request or the state of the fuel cell stack 110 satisfies the predetermined precondition, the controller 140 may determine the hydrogen pressure at the front end of the hydrogen supply valve 130, i.e., the front-end hydrogen pressure. Here, the controller 140 may be configured to determine the front-end hydrogen pressure if only the state depending on the pressure boost request satisfies the predetermined precondition or if only the state of the fuel cell stack 110 satisfies the predetermined precondition, or may be configured to determine the front-end hydrogen pressure if both the state depending on the pressure boost request and the state of the fuel cell stack 110 satisfy the corresponding predetermined preconditions.

The controller 140 may determine the front-end hydrogen pressure by receiving the front-end hydrogen pressure, sensed by a pressure sensor provided at a point located ahead of a point at which the hydrogen supply valve 130 on the hydrogen supply line 120 is provided, from the pressure sensor. For example, the front end point of the hydrogen supply valve 130 may be a point on the hydrogen supply line 120 just before the hydrogen supply valve 130, or a point on the hydrogen supply line 120 just after the hydrogen storage tank (not shown) provided at the front end of the hydrogen supply valve 130. However, these positions are only an example and the present disclosure is not limited thereto.

Further, the controller 140 may determine the opening command value of the hydrogen supply valve 130 based on the determined front-end hydrogen pressure. Here, the controller 140 may determine the opening command value depending on the front-end hydrogen pressure using logic or a data set.

In addition or alternative, the controller 140 may determine the operating state of the fuel cell stack 110, and may determine the opening command value of the hydrogen supply valve 130 based on the determined front-end hydrogen pressure and the determined operating state of the fuel cell stack 110. For example, for this purpose, a pre-stored data map may be provided in the controller 140, and the controller 140 may determine the opening command value corresponding to the front-end hydrogen pressure and the operating state of the fuel cell stack 110 using the corresponding data map.

Meanwhile, the controller 140 may further determine an oxygen crossover rate on the anode side of the fuel cell stack 110, and the controller 140 may determine the opening command value of the hydrogen supply valve 130 in further consideration of the determined oxygen crossover rate. The oxygen crossover rate is a measure of how much oxygen diffuses through a membrane separating the anode side and cathode side of a fuel cell stack. The oxygen crossover rate may be measured in terms of current density (e.g., mA/cm²), which indicates an electrical current that a crossover oxygen would produce if it participated in a reaction. For example, the controller 140 may determine the opening command value that prevents, reduce, or minimizes oxygen crossover by determining and considering the oxygen crossover rate. Excessive oxygen crossover may lead to unwanted reactions at the anode side, reducing the overall efficiency of a fuel cell. Oxygen crossover may contribute to a degradation of a membrane and other components, potentially shortening the fuel cell's lifespan. Higher oxygen crossover rates may decrease the utilization efficiency of hydrogen fuel, as some of it might be used to react with the crossover oxygen instead of generating electrical power. However, this is only an example and the present disclosure is not limited thereto.

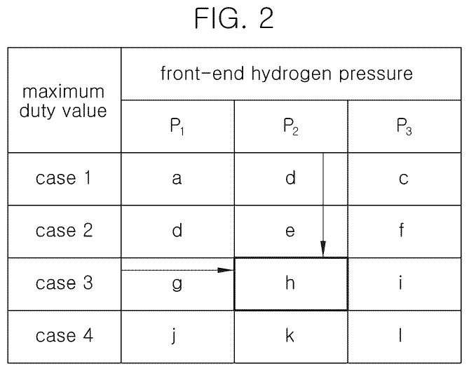

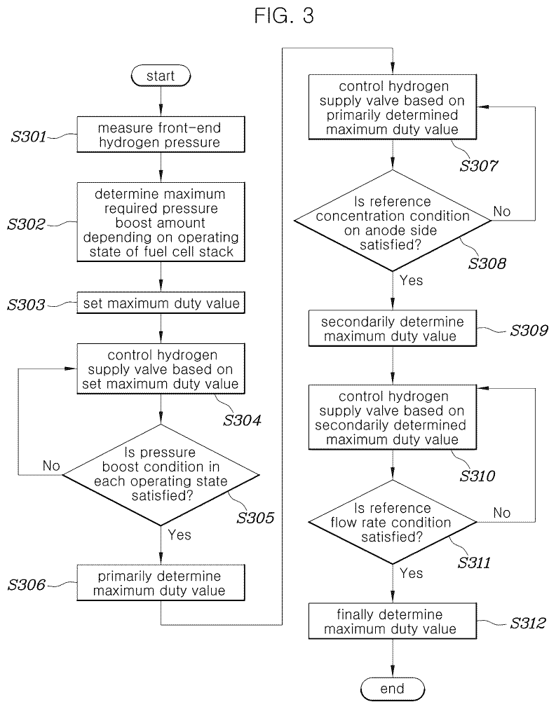

Hereinafter, a process of determining the opening command value of the hydrogen supply valve 130 according to one example of the present disclosure will be described with reference to FIG. 2 and FIG. 3.

FIG. 2 shows an example of the opening command value using the data map according to one example of the present disclosure.

Referring to FIG. 2, the data map that includes front-end hydrogen pressures and operating states of the fuel cell stack 110, which are subdivided from each other, and an upper limit duty value (e.g., a maximum duty value) is derived depending on each of combinations of the front-end hydrogen pressures and the operating states of the fuel cell stack 110 may be prestored in the controller 140. Accordingly, the controller 140 may determine the front-end hydrogen pressure and the operating state of the fuel cell stack 110, and may derive the maximum duty value of the hydrogen supply valve 130 which matches the determined front-end hydrogen pressure and the determined operating state of the fuel cell stack 110 using the data map. For example, if the determined maximum duty value is P₂ and the determined operating state of the fuel cell stack 110 is case 3, the controller 140 may derive the maximum duty value which simultaneously satisfy both P₂ and case 3 using the data map.

The maximum duty values stored in the data map may be values derived through experimentation depending on the front-end hydrogen pressures and the operating states of the fuel cell stack 110. This will be described with reference to FIG. 3.

FIG. 3 shows an example of the maximum duty value of the hydrogen supply valve according to one example of the present disclosure.

Hereinafter, a process of deriving the maximum duty value of the hydrogen supply valve 130 through experimentation will be described.

Referring to FIG. 3, if hydrogen is supplied to the fuel cell stack 110, the front-end hydrogen pressure may be first measured (S301), and the operating state of the fuel cell stack 110 may be determined and the maximum pressure boost amount which is maximally allowable depending on the operating state may be determined (S302). The reason for determining the maximum pressure boost amount may be to consider the worst condition in which the greatest increase in the hydrogen supply pressure occurs in each operating state of the fuel cell stack 110.

Thereafter, if the maximum duty value of the hydrogen supply valve 130 is arbitrarily set (S303) and is transmitted to the controller 140, the controller 140 may control the hydrogen supply valve with an opening command value in which the set maximum duty value is reflected (S304). Further, the controller 140 may perform a process of optimizing the maximum duty value of the hydrogen supply valve 130 while hydrogen is supplied to the fuel cell stack 110 through control of the hydrogen supply valve 130.

First, a pressure boost condition in each operating state of the fuel cell stack 110 may be formed, and the controller 140 may determine whether the pressure boost condition in each operating state of the fuel cell stack 110 depending on the increase in the hydrogen supply pressure is satisfied (S305). If the pressure boost condition in each operating state of the fuel cell stack 110 depending on the increase in the hydrogen supply pressure is not satisfied (No in S305), the controller 140 may boost the hydrogen supply pressure while varying the arbitrarily set maximum duty value upward until the pressure boost condition is satisfied.

If the pressure boost condition in each operating state of the fuel cell stack 110 depending on the increase in the hydrogen supply pressure is satisfied (Yes in S305), the controller 140 may primarily determine a maximum duty value, which has been finally varied upward at a point in time if the pressure boost condition is satisfied, as the maximum duty value to be reflected in the opening command value of the hydrogen supply valve (S306).

Thereafter, the controller 140 may control the hydrogen supply valve 130 with an opening command value in which the primarily determined maximum duty value is reflected, to boost the hydrogen supply pressure by the maximum pressure boost amount (S307). At this time, the controller 140 may determine whether the oxygen concentration on the anode side of the fuel cell stack 110 due to the increase in the hydrogen supply pressure satisfies a reference concentration condition (S308). If the oxygen concentration on the anode side of the fuel cell stack 110 due to the increase in the hydrogen supply pressure does not satisfy the reference concentration condition (No in S308), the controller 140 may boost the hydrogen supply pressure while varying the primarily determined maximum duty value downward until the oxygen concentration on the anode side of the fuel cell stack 110 due to the increase in the hydrogen supply pressure satisfies the reference concentration condition. For example, the fact that the oxygen concentration on the anode side satisfies the reference concentration condition may mean that the oxygen concentration is less than or equal to a predetermined reference oxygen concentration.

If the oxygen concentration on the anode side of the fuel cell stack 110 satisfies the reference concentration condition (Yes in S308), the controller 140 may secondarily determine a maximum duty value, which has been finally varied downward at a point in time if the oxygen concentration on the anode side satisfies the reference concentration condition, as the maximum duty value to be reflected in the opening command value of the hydrogen supply valve 130 (S309).

Thereafter, the controller 140 may control the hydrogen supply valve 130 with an opening command value in which the secondarily determined maximum duty value is reflected, to boost the hydrogen supply pressure by the maximum pressure boost amount again (S310). At this time, the controller 140 may determine a hydrogen flow rate (e.g., 0.1-5 liters per minute) supplied to the fuel cell stack 110 due to the increase in the hydrogen supply pressure, and may determine whether the determined hydrogen flow rate satisfies a reference flow rate condition (S311). If the determined hydrogen flow rate does not satisfy the reference flow rate condition (No in S311), the controller 140 may boost the hydrogen supply pressure while varying the secondarily determined maximum duty value downward until the determined hydrogen flow rate satisfies the reference flow rate condition. For example, the fact that the hydrogen flow rate satisfies the reference flow rate condition may mean that the hydrogen flow rate is less than or equal to a predetermined reference supply flow rate.

If the determined hydrogen flow rate satisfies the reference flow rate condition (Yes in S311), the controller 140 may finally determine a maximum duty value which has been finally varied downward at a point in time if the hydrogen flow rate satisfies the reference flow rate condition, as the maximum duty value to be reflected in the opening command value (S312).

In other words, the controller 140 may initially arbitrarily set the maximum duty value of the hydrogen supply valve 130, and may boost the hydrogen supply pressure while controlling the hydrogen supply valve 130 with the opening command value in which the set maximum duty value is reflected. At this time, the controller 140 may determine the optimal maximum duty value which satisfies all of the pressure boost condition in each operating state of the fuel cell stack 110, the reference concentration condition of the anode side of the fuel cell stack 110, and the reference flow rate condition supplied to the fuel cell stack 110 while varying the initially set maximum duty value upward and downward.

Thereafter, the controller 140 may determine the optimal maximum duty value for each front-end hydrogen pressure by repeatedly performing the above logic (S301 to S312) as the front-end hydrogen pressure changes, and may store the optimal maximum duty value for each front-end hydrogen pressure in the data map so that the front-end hydrogen pressure corresponds to the maximum duty value in each operating state of the fuel cell stack 110. Through the above-described logic, the optimal maximum duty value of the hydrogen supply valve 130 may be stored in the data map pre-stored in the controller 140.

Returning to FIG. 1, the controller 140 may determine the opening command value of the hydrogen supply valve 130 so that the maximum duty value derived through the data map is reflected therein. If the opening command value is determined, the controller 140 may determine the opening degree of the hydrogen supply valve 130 so that the hydrogen supply pressure is boosted based on the determined opening command value.

After controlling the opening degree of the hydrogen supply valve 130, the controller 140 may determine whether boosting of the hydrogen supply pressure depending on the pressure boost request has been completed.

Specifically, the controller 140 may determine the operating state of the fuel cell stack 110, and may determine that boosting of the hydrogen supply pressure depending on the pressure boost request has been completed, if the hydrogen supply pressure reaches a predetermined boost target pressure while satisfying the pressure boost condition corresponding to the operating state of the fuel cell stack 110 in response to the pressure boost request.

For example, if the fuel cell stack 110 is in a start-up state, the controller 140 may determine whether the hydrogen supply pressure depending on pressure boost reaches the boost target pressure within a predetermined start-up time (e.g., within 2 minutes), and may determine that boosting of the hydrogen supply pressure has been completed depending on the pressure boost request in the start-up state of the fuel cell stack 110 if the hydrogen supply pressure reaches the boost target pressure within the start-up time.

If the fuel cell stack 110 is in a shutdown state, the controller 140 may determine whether the hydrogen supply pressure depending on pressure boost reaches the boost target pressure within a predetermined shutdown time (e.g., within 5 minutes), and may determine that boosting of the hydrogen supply pressure has been completed depending on the pressure boost request in the shutdown state of the fuel cell stack 110 if the hydrogen supply pressure reaches the boost target pressure within the shutdown time.

If the fuel cell stack 110 is in an idle state, the controller 140 may determine a boosting rate of the hydrogen supply pressure depending on pressure boost, and may determine that boosting of the hydrogen supply pressure has been completed depending on the pressure boost request in the idle state of the fuel cell stack 110 if the hydrogen supply pressure reaches the boost target pressure while the determined boosting rate satisfies a predetermined target boosting rate.

If the fuel cell stack 110 is in a normal drive state, the controller 140 may determine whether the hydrogen supply pressure depending on pressure boost reaches the boost target pressure within a predetermined start response time, and may determine that boosting of the hydrogen supply pressure has been completed depending on the pressure boost request in the normal drive state of the fuel cell stack 110 if the hydrogen supply pressure reaches the boost target pressure within the start response time.

If an abnormality in hydrogen supply, such as a sudden drop in the front-end hydrogen pressure, occurs and the hydrogen supply pressure depending on pressure boost does not satisfy the pressure boost condition corresponding to the operating state of the fuel cell stack 110, the controller 140 may stop control of the hydrogen supply valve 130 based on the opening command value in which the maximum duty value is reflected.

In addition or alternative, after controlling the opening degree of the hydrogen supply valve 130, if boosting of the hydrogen supply pressure depending on the pressure boost request has been completed, the controller 140 may determine a hydrogen flow rate supplied until boosting of the hydrogen supply pressure has been completed. Further, the controller 140 may perform purging (e.g., removal of residual gases and moisture) if the determined hydrogen flow rate exceeds a predetermined reference flow This rate. This means that, even if the controller 140 controls the hydrogen supply valve 130 based on the opening command value in which the maximum duty value is reflected, the actual amount of hydrogen flowing into the fuel cell stack 110 may be excessive, and thereby, oxygen may flow to the anode side of the fuel cell stack 110. The purging may be performed to prevent the build-up of unreacted hydrogen and oxygen within the fuel cell stack, which may lead to inefficiencies or hazardous conditions, to avoid water build-up, which may block gas flow channels and reduce the performance of the fuel cell, to ensure the fuel cell stack operates at optimal efficiency by providing a clean environment for the chemical reactions, to protect the fuel cell components from degradation that may occur due to residual gases or moisture.

Accordingly, in order to perform stable control, the controller 140 may determine that oxygen has flowed to the anode side if the hydrogen flow rate exceeds a reference flow rate based on the hydrogen flow rate supplied to the fuel cell stack 110, and may thus perform purging to discharge oxygen having flowed to the anode side. Here, the fuel cell system according to one example of the present disclosure may further include a purge valve 150 provided on the anode side of the fuel cell stack 110, and the controller 140 may control the purge valve 140 to perform purging if the hydrogen flow rate exceeds the reference flow rate.

Meanwhile, in implementation of the controller 140 according to one example of the present disclosure, the controller 140 may be a fuel cell control unit (FCU) provided to control the entirety of the above-described fuel cell system. However, this is only an example and the present disclosure is not limited thereto. For example, the controller 140 may be implemented as a control unit provided separately from the fuel cell control unit, and may be implemented with functions which are distributed to two or more different control units.

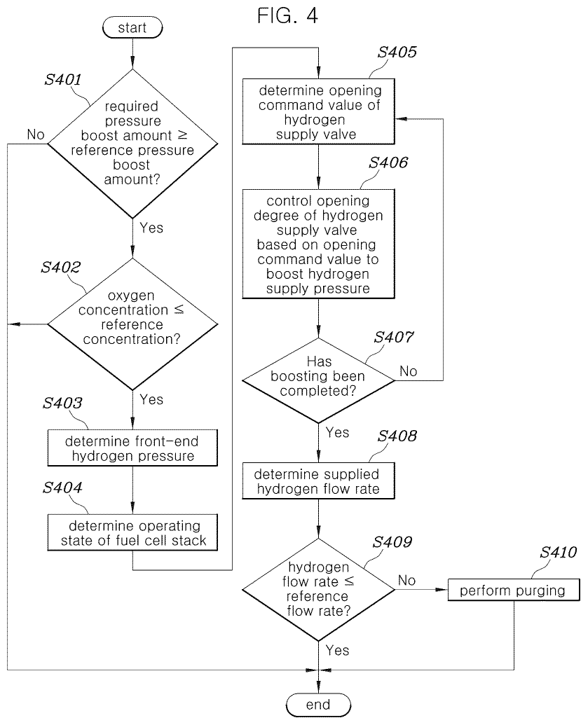

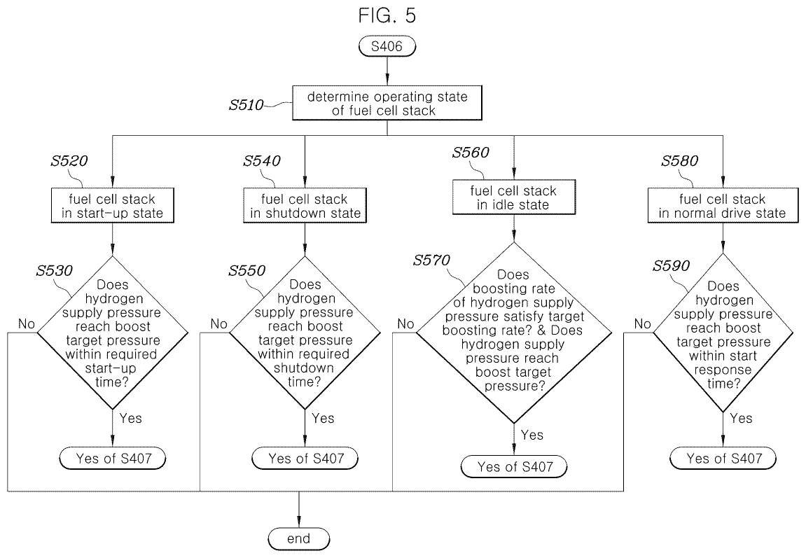

Hereinafter, based on the fuel cell system described above with reference to FIG. 1, a control method of the fuel cell system according to one example of the present disclosure will be described with reference to FIG. 4 and FIG. 5. In addition or alternative, the detailed description of each operation below has been already given through FIG. 1 and FIG. 2, and will thus be omitted, and the control method will be described briefly below.

FIG. 4 and FIG. 5 show examples of the control method of the fuel cell system according to one example of the present disclosure.

First, referring to FIG. 4, if a pressure boost request to boost the hydrogen supply pressure occurs, the controller 140 may determine whether a pressure boost amount depending on the pressure boost request is greater than or equal to a predetermined reference pressure boost amount (S401), and may determine whether a hydrogen concentration on the anode side of the fuel cell stack 110 is less than or equal to a predetermined reference concentration (S402). Through these determination processes (S401 and S402), the controller 140 may determine whether a state depending on the pressure boost request or the state of the fuel cell stack 110 satisfies a predetermined precondition. In FIG. 4, in one example, if the pressure boost amount depending on the pressure boost request is greater than or equal to the predetermined reference pressure boost amount (Yes in S401) and the hydrogen concentration on the anode side of the fuel cell stack 110 is less than or equal to the predetermined reference concentration in (Yes S402), it may be determined that the state depending on the pressure boost request and the state of the fuel cell stack 110 satisfy the predetermined preconditions.

If the state depending on the pressure boost request and the state of the fuel cell stack 110 satisfy the predetermined preconditions, the controller 140 may determine a front-end hydrogen pressure, i.e., a hydrogen pressure at the front end of the hydrogen supply valve 130 (S403). Further, the controller 140 may determine the operating state of the fuel cell stack 110 (S404). Although, in FIG. 4, Operation S403 and Operation S404 are described as being performed sequentially, this is only an example, and Operation S403 and Operation S404 may be performed simultaneously.

In addition or alternative, the controller 140 may determine an opening command value of the hydrogen supply valve 130 based on the front-end hydrogen pressure and the operating state of the fuel cell stack 110 (S405). At this time, the controller 140 may derive a maximum duty value corresponding to the front-end hydrogen pressure and the operating state of the fuel cell stack 110 using a prestored data map, and may determine the opening command value so that the derived maximum duty value is reflected therein.

The controller 140 may control the opening degree of the hydrogen supply valve 130 based on the determined opening command value to boost the hydrogen supply pressure (S406).

After controlling the opening degree, the controller 140 may determine whether boosting of the hydrogen supply pressure has been completed (S407), and may determine a hydrogen flow rate supplied until boosting of the hydrogen supply pressure has been completed (S408), if boosting of the hydrogen supply pressure has been completed (Yes in S407).

If the determined hydrogen flow rate exceeds a predetermined reference flow rate (No in S409), the controller 140 may control the purge valve 150 to perform purging (S410).

Hereinafter, referring to FIG. 5, Operation S407 of determining whether boosting of the hydrogen supply pressure has been completed after controlling the opening degree of the hydrogen supply valve 130 will be described in detail.

After controlling the opening degree of the hydrogen supply valve 130 (S406), the controller 140 may determine the operating state of the fuel cell stack 110 (S510), and may determine whether boosting of the hydrogen supply pressure has been completed by determining whether the hydrogen supply pressure depending on pressure boost reaches a predetermined boost target pressure while satisfying a pressure boost condition corresponding to the operating state of the fuel cell stack 110.

Specifically, if the fuel cell stack 110 is in a start-up state (S520), the controller 140 may determine whether the hydrogen supply pressure depending on pressure boost reaches boost the target pressure within a predetermined start-up time (S530). If the hydrogen supply pressure reaches the boost target pressure within the start-up time (Yes in S530), the controller 140 may determine that boosting of the hydrogen supply pressure has been completed (Yes in S407).

If the fuel cell stack 110 is in a shutdown state (S540), the controller 140 may determine whether the hydrogen supply pressure depending on pressure boost reaches the boost target pressure within a predetermined shutdown time (S550). If the hydrogen supply pressure reaches the boost target pressure within the shutdown time (Yes in S550), the controller 140 may determine that boosting of the hydrogen supply pressure has been completed (Yes in S407).

If the fuel cell stack 110 is in an idle state (S560), the controller 140 may determine whether the boosting rate of the hydrogen supply pressure depending on pressure boost satisfies a predetermined target boosting rate and the hydrogen supply pressure reaches the boost target pressure (S570). If the boosting rate satisfies the predetermined target boosting rate and the hydrogen supply pressure reaches the boost target pressure (Yes in S570), the controller 140 may determine that boosting of the hydrogen supply pressure has been completed (Yes in S407).

If the fuel cell stack 110 is in a normal drive state (S580), the controller 140 may determine whether the hydrogen supply pressure depending on pressure boost reaches the boost target pressure within a predetermined start response time (S590). If the hydrogen supply pressure reaches the boost target pressure within the start response time (Yes in S590), the controller 140 may determine that boosting of the hydrogen supply pressure has been completed (Yes in S407).

Various examples of the present disclosure are directed to providing a fuel cell system and a control method thereof, which can prevent oxygen from flowing to the anode of a fuel cell stack if hydrogen is momentarily supplied to the anode.

The technical objects to be achieved in an example of the present disclosure are not limited to the above-mentioned objects, and other technical objects not mentioned will be clearly understood by those skilled in the art from the following description.

In accordance with an example of the present disclosure, the above and other objects can be accomplished by the provision a fuel cell system including a fuel cell stack, a hydrogen supply line connected to an anode side of the fuel cell stack to supply hydrogen to the fuel cell stack, a hydrogen supply valve provided on the hydrogen supply line to adjust hydrogen supplied to the fuel cell stack, and a controller configured to determine a front-end hydrogen pressure at a front end of the hydrogen supply valve if a pressure boost request to boost a hydrogen supply pressure occurs, determine an opening command value of the hydrogen supply valve based on the determined front-end hydrogen pressure, and control an opening degree of the hydrogen supply valve based on the determined opening command value to boost the hydrogen supply pressure.

For example, if the pressure boost request occurs, the controller may determine whether a state depending on the pressure boost request or a state of the fuel cell stack satisfies a predetermined precondition, and may determine the front-end hydrogen pressure if the state or the state of the fuel cell stack satisfies the predetermined precondition.

For example, if a pressure boost amount depending on the pressure boost request is greater than or equal to a predetermined reference pressure boost amount, the controller may determine that the state satisfies the precondition.

For example, the controller may determine a hydrogen concentration on the anode side of the fuel cell stack, and may determine that the state of the fuel cell stack satisfies the precondition if the determined hydrogen concentration is less than or equal to a predetermined reference concentration.

For example, the controller may determine an operating state of the fuel cell stack, and may determine the opening command value based on the front-end hydrogen pressure and the determined operating state.

For example, the controller may derive a maximum duty value of the hydrogen supply valve configured to match the front-end hydrogen pressure and the determined operating state through a prestored data map, and may determine the opening command value so that the derived maximum duty value is reflected therein.

For example, the controller may determine an oxygen crossover rate on the anode side of the fuel cell stack, and may determine the opening command value in further consideration of the determined oxygen crossover rate.

For example, after controlling the opening degree of the hydrogen supply valve, the controller may determine an operating state of the fuel cell stack, and may determine that boosting of the hydrogen supply pressure has been completed if the hydrogen supply pressure depending on the pressure boost request reaches a predetermined boost target pressure while satisfying a pressure boost condition corresponding to the determined operating state.

For example, if the fuel cell stack is in a start-up state, the controller may determine that boosting of the hydrogen supply pressure has been completed depending on the pressure boost request if the hydrogen supply pressure reaches the boost target pressure within a predetermined start-up time.

For example, if the fuel cell stack is in a shutdown state, the controller may determine that boosting of the hydrogen supply pressure has been completed depending on the pressure boost request if the hydrogen supply pressure reaches the boost target pressure within a predetermined shutdown time.

For example, if the fuel cell stack is in an idle state, the controller may determine that boosting of the hydrogen supply pressure has been completed depending on the pressure boost request if the hydrogen supply pressure reaches the boost target pressure while a boosting rate of the hydrogen supply pressure satisfies a predetermined target boosting rate.

For example, if the fuel cell stack is in a normal drive state, the controller may determine that boosting of the hydrogen supply pressure has been completed depending on the pressure boost request if the hydrogen supply pressure reaches the boost target pressure within predetermined start response time.

For example, after controlling the opening degree of the hydrogen supply valve, the controller may determine a hydrogen flow rate supplied until boosting of the hydrogen supply pressure has been completed if boosting of the hydrogen supply pressure has been completed, and may perform purging if the determined hydrogen flow rate exceeds a predetermined reference flow rate.

In accordance with another example of the present disclosure, there is provided a control method of a fuel cell system including determining a front-end hydrogen pressure at a front end of a hydrogen supply valve if a pressure boost request to boost a hydrogen supply pressure occurs, determining an opening command value of the hydrogen supply valve based on the front-end hydrogen pressure, and controlling an opening degree of the hydrogen supply valve based on the determined opening command value to boost the hydrogen supply pressure.

For example, determining the front-end hydrogen pressure may include determining whether a state depending on the pressure boost request or a state of the fuel cell stack satisfies a predetermined precondition if the pressure boost request occurs, and determining the front-end hydrogen pressure if the state or the state of the fuel cell stack satisfies the predetermined precondition.

For example, determining the opening command value may include determining an operating state of the fuel cell stack, and determining the opening command value based on the front-end hydrogen pressure and the determined operating state.

For example, the control method may further include, after controlling the opening degree of the hydrogen supply valve, determining an operating state of the fuel cell stack, and determining that boosting of the hydrogen supply pressure has been completed if the hydrogen supply pressure depending on the pressure boost request reaches a predetermined boost target pressure while satisfying a pressure boost condition corresponding to the determined operating state.

For example, the control method may further include, after controlling the opening degree of the hydrogen supply valve, determining a hydrogen flow rate supplied until boosting of the hydrogen supply pressure has been completed if boosting of the hydrogen supply pressure has been completed, and performing purging if the determined hydrogen flow rate exceeds a predetermined reference flow rate.

According to one example of the present disclosure, since the opening command value of a hydrogen supply valve is controlled to prevent oxygen from flowing to the anode side of a hydrogen is momentarily supplied to the fuel cell stack, it is possible to prevent oxygen from flowing to the anode side of the fuel cell stack by controlling an existing system without installing a separate oxygen inflow prevention device.

In addition or alternative, since preventing inflow of oxygen to the anode side of the fuel cell stack if hydrogen is momentarily supplied to the fuel cell stack, it is possible to improve durability of the fuel cell stack.

The effects of the present disclosure are not limited to the effects mentioned above, and other effects not mentioned will be clearly understood by those skilled in the art from the above description.

As described above, in the fuel cell system and the control method thereof according to the present disclosure, since the opening command value of the hydrogen supply valve is controlled to prevent oxygen from flowing to the anode side of the fuel cell stack if hydrogen is momentarily supplied to the fuel cell stack, it is possible to prevent oxygen from flowing to the anode side of the fuel cell stack by controlling an existing system without installing a separate oxygen inflow prevention device.

In addition or alternative, since preventing inflow of oxygen to the anode side of the fuel cell stack if hydrogen is momentarily supplied to the fuel cell stack, it is possible to improve durability of the fuel cell stack.

While the present disclosure has been explained in relation to its specific examples, it is to be understood that various modifications and changes thereof will become apparent to those skilled in the art without departing from the technical spirit of the present disclosure as provided by the appended claims.

Furthermore, the term related to a control device such as “controller”, “control apparatus”, “control unit”, “control device”, “control module”, or “server”, etc. refers to a hardware device including a memory and a processor configured to execute one or more steps interpreted as an algorithm structure. The memory stores algorithm steps, and the processor executes the algorithm steps to perform one or more processes of a method in accordance with various examples of present the disclosure. The control device according to examples of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured to process data according to a program provided from the memory, and may be configured to generate a control signal according to the processing result.

The control device may be at least one microprocessor operated by a predetermined program which may include a series of commands for carrying out the method included in the aforementioned various examples of the present disclosure.

The aforementioned disclosure can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMS, magnetic tapes, floppy discs, optical data storage devices, etc. and implementation as carrier waves (e.g., transmission over the Internet). Examples of the program instruction include machine language code such as those generated by a compiler, as well as high-level language code which may be executed by a computer using an interpreter or the like.

In various examples of the present disclosure, each operation described above may be performed by a control device, and the control device may be configured by a plurality of control devices, or an integrated single control device.

In various examples of the present disclosure, the memory and the processor may be provided as one chip, or provided as separate chips.

In various examples of the present disclosure, the scope of the present disclosure includes software or machine-executable commands (e.g., an operating system, an application, firmware, a program, etc.) for enabling operations according to the methods of various examples to be executed on an apparatus or a computer, a non-transitory computer-readable medium including such software or commands stored thereon and executable on the apparatus or the computer.

In various examples of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the examples with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise. In examples of the present disclosure, “at least one of A and B” may refer to “at least one of A or B” or “at least one of combinations of one or more of A and B”. In addition or alternative, “one or more of A and B” may refer to “one or more of A or B” or “one or more of combinations of one or more of A and B”.

In the example of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

The foregoing descriptions of specific examples of the present disclosure have been presented for purposes of illustration and description. They are not intended to be exhaustive or to limit the present disclosure to the precise forms disclosed, and obviously many modifications and variations are possible in light of the above teachings. The examples were chosen and described in order to explain certain principles of the disclosure and their practical application, to enable others skilled in the art to make and utilize various examples of the present disclosure, as well as various alternatives and modifications thereof. It is intended that the scope of the present disclosure be defined by the Claims appended hereto and their equivalents.

What is claimed is:

1. A system comprising:
a fuel cell stack;
a hydrogen supply line configured to be coupled to an anode side of the fuel cell stack and supply hydrogen to the fuel cell stack;
a hydrogen supply valve, associated with the hydrogen supply line, configured to adjust an amount of hydrogen supplied to the fuel cell stack; and
a controller configured to:
determine, based on a pressure boost request to boost a hydrogen supply pressure, a front-end hydrogen pressure at a front end of the hydrogen supply valve,
determine, based on the determined front-end hydrogen pressure, an opening command value of the hydrogen supply valve, and
control, based on the determined opening command value, an opening degree of the hydrogen supply valve to boost the hydrogen supply pressure.

2. The system of claim 1, wherein, based on the pressure boost request, the controller is further configured to:
determine whether a required state or a state of the fuel cell stack satisfies a precondition, and
determine, based on the required state or the state of the fuel cell stack satisfying the precondition, the front-end hydrogen pressure.

3. The system of claim 2, wherein, based on a required pressure boost amount associated with the pressure boost request being greater than or equal to a reference pressure boost amount, the controller is further configured to determine that the required state satisfies the precondition.

4. The system of claim 2, wherein the controller is further configured to:
determine a hydrogen concentration on the anode side of the fuel cell stack, and
determine, based on the determined hydrogen concentration being less than or equal to a reference concentration, that the state of the fuel cell stack satisfies the precondition.

5. The system of claim 1, wherein the controller is further configured to:
determine an operating state of the fuel cell stack, and
determine, based on the front-end hydrogen pressure and the determined operating state, the opening command value.

6. The system of claim 5, wherein the controller is configured to:
derive a maximum duty value of the hydrogen supply valve, wherein the hydrogen supply valve is configured to match the front-end hydrogen pressure and the determined operating state through a prestored data map, and
determine, based on the derived maximum duty value, the opening command value.

7. The system of claim 5, wherein the controller is further configured to:
determine an oxygen crossover rate on the anode side of the fuel cell stack, and
determine, based on the determined oxygen crossover rate, the opening command value.

8. The system of claim 1, wherein, after controlling the opening degree of the hydrogen supply valve, the controller is further configured to:
determine an operating state of the fuel cell stack, and
determine, based on the hydrogen supply pressure reaching a boost target pressure while satisfying a pressure boost condition corresponding to the determined operating state, that boosting of the hydrogen supply pressure has been completed.

9. The system of claim 8, wherein, based on the fuel cell stack being in a start-up state, the controller is further configured to determine, based on the hydrogen supply pressure reaching the boost target pressure within a required start-up time, that boosting of the hydrogen supply pressure has been completed.

10. The system of claim 8, wherein, based on the fuel cell stack being in a shutdown state, the controller is further configured to determine, based on the hydrogen supply pressure reaching the boost target pressure within a required shutdown time, that boosting of the hydrogen supply pressure has been completed.

11. The system of claim 8, wherein, based on the fuel cell stack being in an idle state, the controller is further configured to determine, based on the hydrogen supply pressure reaching the boost target pressure while a boosting rate of the hydrogen supply pressure satisfies a target boosting rate, that boosting of the hydrogen supply pressure has been completed.

12. The system of claim 8, wherein, based on the fuel cell stack being in a normal drive state, the controller is further configured to determine, based on the hydrogen supply pressure reaching the boost target pressure within a start response time, that boosting of the hydrogen supply pressure has been completed.

13. The system of claim 1, wherein, after controlling the opening degree of the hydrogen supply valve, the controller is further configured to:
determine a hydrogen flow rate of supplied hydrogen until boosting of the hydrogen supply pressure has been completed, and
perform, based on the determined hydrogen flow rate exceeding a reference flow rate, a purging process.

14. A method performed by a fuel cell system for controlling the fuel cell system, the method comprising:
determining, based on a pressure boost request to boost a hydrogen supply pressure, a front-end hydrogen pressure at a front end of a hydrogen supply valve;
determining, based on the determined front-end hydrogen pressure, an opening command value of the hydrogen supply valve; and
controlling, based on the determined opening command value, an opening degree of the hydrogen supply valve to boost the hydrogen supply pressure.

15. The method of claim 14, wherein determining the front-end hydrogen pressure comprises:
determining, based on the pressure boost request, whether a required state or a state of a fuel cell stack of the fuel cell system satisfies a precondition; and
determining, based on the required state or the state of the fuel cell stack satisfying the precondition, the front-end hydrogen pressure.

16. The method of claim 14, wherein determining the opening command value comprises:
determining an operating state of a fuel cell stack of the fuel cell system; and
determining, based on the front-end hydrogen pressure and the determined operating state, the opening command value.

17. The system of claim 16, wherein determining the opening command value comprises:
deriving a maximum duty value of the hydrogen supply valve, wherein the hydrogen supply valve is configured to match the front-end hydrogen pressure and the determined operating state through a prestored data map, and
determining, based on the derived maximum duty value, the opening command value.

18. The method of claim 16, wherein determining the opening command value comprises:
determining an oxygen crossover rate on an anode side of a fuel cell stack of the fuel cell system; and
determining, based on the determined oxygen crossover rate, the opening command value.

19. The method of claim 14, further comprising, after controlling the opening degree of the hydrogen supply valve;
determining an operating state of a fuel cell stack of the fuel cell system; and
determining, based on the hydrogen supply pressure reaching a boost target pressure while satisfying a pressure boost condition corresponding to the determined operating state, that boosting of the hydrogen supply pressure has been completed.

20. The method of claim 14, further comprising, after controlling the opening degree of the hydrogen supply valve:
determining a hydrogen flow rate of hydrogen supplied until boosting of the hydrogen supply pressure has been completed; and
performing, based on the determined hydrogen flow rate exceeding a reference flow rate, a purging process.
